(19) United States
(12) Patent Application Publication
(10) Pub. No.: US 2019/0108097 A1
(43) Pub. Date: Apr. 11, 2019

(54) SYSTEMS AND METHODS FOR BACKING UP FILES

(71) Applicants: Johnathan Wen Jing Zhuang, Melbourne (AU); Pece Nikolovski, Melbourne (AU)

(72) Inventors: Johnathan Wen Jing Zhuang, Melbourne (AU); Pece Nikolovski, Melbourne (AU)

(21) Appl. No.: 15/727,240

(22) Filed: Oct. 6, 2017

(51) Int. Cl. G06F 11/14; H04L 29/06

(52) U.S. Cl. CPC G06F 11/1448; H04L 67/10; H04L 63/08; H04L 63/0428

(57) ABSTRACT

A system and method of real time and automatic back up of media files, e.g., image, audio, and video files, etc., from a user device to a media storage device. A process on the user device detects the presence of a new media file, and initiates the backup process. The backup process determines if the media storage device is available over a local network. If so, the user device transfers the media file to the media storage device for backup. The media file may be encrypted. If the media storage device is not available over a local network, one or more servers may be used to facilitate a direct remote connection between the user device and the media storage device to enable the backup. If a direct remote connection is not possible, a server may be used as a relay to transfer the media file from the user device to the media storage device. After the media files are backed up, user-defined and/or automatically-generated tags may be associated with the media files as metadata. Backed-up media files may also be added to media collections.

### BACKGROUND

The present disclosure relates generally to systems and methods for automatically backing up files to a storage device local to the user.

Regularly backing up files, including media files (e.g., audio, image, and video files), is a persistent struggle for many users. Conventionally, users can manually backup files created on a user device to a computing device or storage device they own, usually via wireless or wired communication. However this method has many pitfalls. It is error prone, with users often failing to backup certain files. It is too infrequent, with backups only being performed every few weeks or even months. It is also difficult to verify that the backed up files are valid.

Alternately, “Cloud” solutions exist that allow media files created on a user device to be backed up to an Enterprise server (i.e., a computing device not owned or accessible by the user). While this method overcomes some of the problems with manual backups, this method prompts privacy and security concerns as the data is no longer within user's physical proximity or control.

Thus, there exists a need for a backup solution which overcomes the deficiencies of the prior art systems, and allows full user control and ownership of files, including media files.

### SUMMARY

In accordance with the foregoing needs and others, methods, systems and apparatuses, including computer programs encoded on computer storage media, are provided for the automatic backup of files, including media files, from a user device to a local storage device.

The file backup system includes a media storage device and one or more user devices that communicate with the media storage device locally (e.g., over a local network) and/or remotely (e.g., over a wide network such as the internet). Each user device is paired with a media storage device, and the system backs up all files that need to be backed up to the paired media storage device. If the user device is local to the media storage device, e.g., they are on the same local network, the user device backs up the files directly to the media storage device. If the user device is remote from the media storage device, the user device sends a connection request to an authentication server, requesting that the user device be connected to the paired media storage device. The authentication server creates a connection between the user device and the media storage device, and the user device uses this connection to back up the files.

When the user device detects that a new file (e.g., a media file) has been created, the user device checks if the media storage device is available over a local network through, e.g., network discovery. If so, the user device sends the new file to the media storage device via the local network and the file is saved (backed up) to the media storage device. An encryption method may be used to enhance security. The media storage device may authenticate the user and/or user device prior to allowing the user device to send the media file.

If the user device is remote from the media storage device, e.g., the media storage device is not available over a local network, the user device sends a connection request to an authentication server over a wide area network, e.g., the internet. The authentication server keeps a list of media storage devices, including network address, e.g., IP addresses, for the media storage devices. The authentication server may also keep track of the communication status for the media storage devices, e.g., whether each media storage device currently has an open communication channel with the authentication server.

The authentication server also stores information regarding users and user devices, and which media storage device is associated with each user device. Based on the stored associations and/or information contained in the connection request, the authentication server determines the media storage device associated with the user device, then communicates with the media storage device to establish a connection between the user device and the media storage device. The user device can then transfer the file to the media storage device to be backed up. The user and/or user device may be authenticated by the authentication server prior to establishing the connection between the user device and the media storage device.

If the media storage device is unavailable, then the file may instead be backed up to a fallback server. After the media storage device becomes available again, the file may be transferred from the fallback server to the media storage device.

After the file is backed up, it may be analyzed to generate tags and/or other metadata. The file may then be shared with others and/or added to one or more media collections, e.g., albums, playlists, slideshows, etc., based on predefined rules as applied to the file and/or the file's metadata.

The system may also include one or more digital picture frames or other devices primarily meant for media displays. These devices are associated with and have access to the media storage device, but are only able to download media files from the media storage device and cannot back up media files. Each frame or other display device may be associated with a media collection and/or a media with specific metadata such as tags. With respect to a frame displaying pictures, the frame will, in general, show the pictures in the media collection in some sequence, e.g., a loop or randomly, as would be known by one of ordinary skill in the art. The frames may be located anywhere in the world, e.g., at a relative's house located in another country who wants to receive automatic updates of images of a new baby.

When a new picture, video, or other media file is added to a media collection, the updated media collection is sent to the devices associated with the playlist. Metadata associated with the new media file may also be sent to the associated devices, with the media file itself only being sent to an associated device after a specific request for the media file from the associated device. In an alternative embodiment, the media file may be sent to the associated devices without a specific request.

Because this process, including the backup of the media, adding the media to the playlist, and updating the playlist on the frame, happens automatically, frames or other display devices anywhere around the world can receive instant updates when relevant media is created.

The disclosed system meets the needs of anyone who takes pictures, videos, or creates other types of media. It improves the timeliness and reliability of backups for media files created or generated on a user's mobile computing device. The system also facilitates the appropriate ownership of the backed up media files by backing up securely and privately to a storage computing device the user owns and have physical access to.

In addition, the disclosed system preserves privacy of data by transmitting the media files fully encrypted and only allowing user-owned devices to decrypt the data.

### BRIEF DESCRIPTION OF THE DRAWINGS

FIG. 1 is a block diagram of the system components according to one embodiment.

FIG. 2 is a block diagram of a media storage device according to one embodiment.

FIG. 3 is a flowchart illustrating a method for registering a first or owner user according to one embodiment.

FIG. 4 is a flowchart illustrating a method for registering a secondary user according to one embodiment.

FIGS. 5A and 5B are a flowchart illustrating a method for backing up from a user device to a media storage device according to one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

As used herein, “file” describes any collection of data, whether or not a distinct file as described by, e.g., a FAT (File Allocation Table), NTFS (New Technology File System), etc. “File” also includes any associated metadata.

“Metadata” includes, but is not limited to, file creation date and time, information regarding the user and/or user device that created the media file, geographical identification information (e.g., geotags), file size, last modified date and time, file type, length (for video and audio media), thumbnail(s), automatically-generated tags (e.g., tags using facial recognition to identify person in a photo, tags using image recognition techniques to identify features, e.g., objects, scenery, etc., of a photo), and user-created tags.

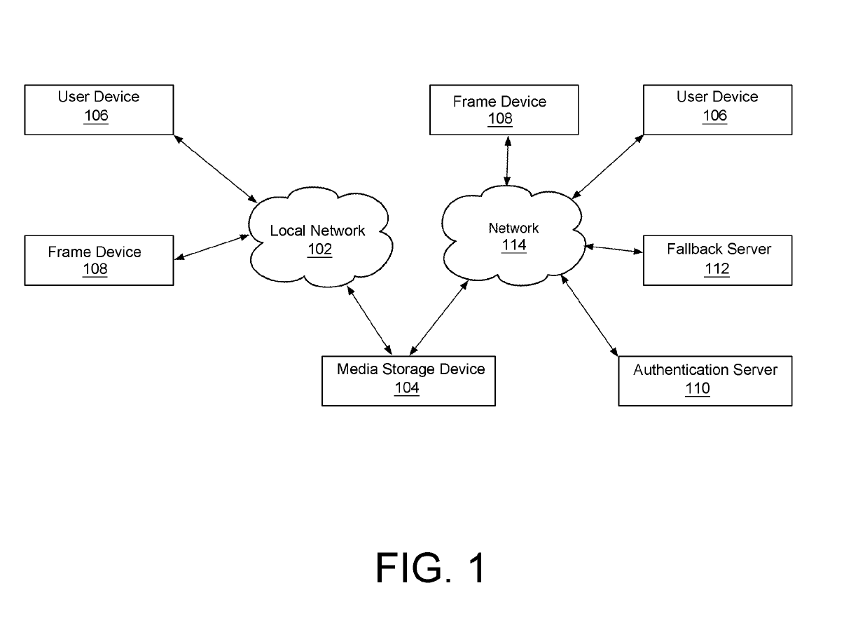

FIG. 1 illustrates one embodiment of a system 100 of the present disclosure. System 100 includes one or more user devices 106 and media storage device 104, which communicate through local network 102. Local network 102 may comprise any type of local network, e.g., a LAN, wireless network, etc. User devices 106 can be any type of device capable of communicating with media storage device 104 through network 102, e.g., desktop computers, laptop computers, notebook computers, tablet devices, cellular phones, cameras, video cameras, personal digital assistants, etc. Media storage device 104 may comprise any device capable of performing one or more of the methods described herein, e.g., a desktop or laptop computer, a server, etc. The media storage device may store media on any storage medium, e.g., a hard drive, optical drive, etc. The storage medium may be internal or external to the media storage device.

While the media storage device is generally described herein as a single device, it may comprise multiple devices. For example, the media storage device may comprise separate servers, e.g., a web server and a database server. As another example, the media storage device may comprise several devices, with one device configured for efficient storage of images, and another device configured for efficient storage of videos.

The media storage device stores the media files, including related metadata, that users have backed up to it. The media storage device also stores media collections, such as playlists, photo albums, slide shows, etc. A media collection may be stored as a separate data structure, e.g., a list of photos for a photo album. This type of media collection may be created by a user by identifying the media files that the user wants in the media collection. The user can identify media files individually, or select all files with certain metadata, such as tags. A user can also set rules that to automatically update the media collection based on media file metadata when files are backed up. For example, a user can create a media collection, e.g., a landscape collection, by selecting all photos that have been tagged as a landscape. The user can also add additional photos to the collection. The user can then set up a rule that adds to the landscape collection all newly backed up media files that the system identifies as including a landscape.

Additionally or alternatively, a media collection may be identified as a set of all media files that meet certain rules regarding media file metadata. This type of media collection will dynamically change as media files are backed up to the media storage device.

The media storage device stores information about users and user devices. User information stored by the media storage device may include user id, user email address, and user role. User roles include at least an “owner” role and a “secondary user” role. An owner user can grant access to and revoke access from secondary users. In one embodiment, the owner role may be assigned to the first user to access the media storage device. There may be one or several ‘owners’ per media storage device, depending on the needs of the particular implementation.

User information stored by the media storage device may also include permissions. Permissions include, but are not limited to, permissions to access specific media files, specific media collections, or media files or collections with specified metadata; permissions to grant access to secondary users; permissions to invite other users; and permissions to alter other user's permissions. The first, or owner, user typically has all permissions, and can grant other users permission as desired.

Permissions to access media files and media collections may include the particular file or collection and the type of access allowed (e.g., read-only, read/write, etc.). For example, a user's grandparents (a secondary user) may be granted permission to access the user's photo album of a recent trip abroad (a media collection). Permissions to access media files with specific metadata may include the metadata and the type of access allowed (e.g., read-only, read/write, etc.). For example, a user's sibling, who only cares about photos or videos of the user's new baby, may be granted permission to access all media files with a tag identifying the subject as the new baby.

Permissions can also be negative, e.g., a user may be given access to all media files except for files with specific metadata.

User device information stored by the media storage device may include device id (e.g., UUID, MAC Address, etc.), user id (the user associated with the device), device type (e.g., smartphone, laptop, or specific manufacturer and model (e.g., iPhone 7s, Samsung Galaxy S8, etc.), etc.), device status, etc.

The media storage device may also store user login credentials with respect to third party sites, such as Facebook, Twitter, Google, etc., obtained using a third-party authentication protocol, e.g., OAuth, etc. This enables the user to be authenticated by the media storage device using the respective third party login.

User device information stored by the media storage device can also include permissions, as described above with respect to user information. In one embodiment, both the user and the user device must have the required permission to perform the desired function, e.g., to access a media file. In one embodiment, user permissions are applied before user device permissions. For example, a user may have full read and write access permissions, but the user may decide to give a particular frame only read access to a specific media collection. As another example, a secondary user may have read access to several media collections, but the secondary user may decide to give a particular frame only access to one of the media collections.

In one embodiment, the device status information indicates the status of the device with respect to access to the media storage device. Statuses may include active (user device is authorized to access the media storage device), pending approval (user device has requested access to the media storage device, but is not yet approved), and blocked (user device is blocked from using the media storage device).

The media storage device stores a whitelist of all user devices that are authorized to access the media storage device. The whitelist is used to authenticate any device attempting to access the media storage device, whether to back up media or to access media. The whitelist may identify user devices by storing any uniquely identifying characteristic of the user device, e.g. UUID, MAC address, etc. In one embodiment, the whitelist comprises the user devices with an active status.

The media storage device also stores any required encryption keys, e.g., the media storage device's public and private encryption keys, user public encryption keys, and a symmetric encryption key for encrypting media files. A different symmetric encryption key may be used for each active user device.

The user device stores information about the media storage device that is associated with the user device. This allows the user device to automatically connect with the media storage device if they are both on the same local wireless or wired network. For example, the user device may store the id of the media storage device.

The user device also stores the user id of its associated user, its own unique device id, and any required encryption keys, e.g., the user's public and private encryption keys, the media storage device public encryption key, and a symmetric encryption key for encrypting media files.

In addition to backing up media to the media storage device through a local wireless or wired network, user devices 106 may back up media through a wide area network, e.g., the internet. To this end, the system also includes authentication server 110, fallback server 112, and wide area network 114. Wide area network 114 may comprise any type of local network, e.g., a LAN, a WAN, wireless network, the internet, a cloud network, etc.

Authentication server 110 authenticates user devices attempting to access a media storage device, such as media storage device 104, over a wide network. While FIG. 1 only shows one media storage device, the authentication server can authenticate user devices attempting to connect to one of multiple media storage devices.

Authentication server 110 may comprise any device capable of performing the functionality described herein with respect to the authentication server, e.g., a desktop or laptop computer, a server computer, etc. The authentication server includes a processor and a memory. Authentication server 110 stores in the memory a list of media storage device ids, and their associated network addresses, e.g., ip addresses. Authentication server 110 also stores information about the current connection status with each media storage device, e.g., whether the connection is active or passive. This may be determined using pings, i.e., queries to determine if there is a connection to the media storage device.

The authentication server also stores any required encryption keys, e.g., the media storage device's public key, etc.

The authentication server stores information regarding users and user devices. The information stored for users includes user id and profile ids, e.g., email, facebook id, and phone number. The information stored for user devices includes the user device id and any required encryption key, e.g., the user device's public key.

The authentication server also stores associations between user devices and media storage devices. When the authentication server receives a connection request from a user device, the authentication server authenticates the user device, forwards the connection request to the media storage device associated with the user device, and facilitates creating a direct peer-to-peer connection between the user device and the media storage device.

The connection request by the user device includes information needed to authenticate the user device against the media storage device it is attempting to connect to. This information may include, e.g., media storage device id, user id, and user device id. The authentication server can then verify that the sent user id and/or user device id are associated with the sent media storage device id. The connection request may use a known communication standard, e.g., a JSON Web Token (JWT) that contains the above information and is signed with the user device's private key, to help ensure the connection request is valid.

The peer-to-peer connection may be created using a connection protocol, e.g., STUN (Session Traversal Utilities for NAT), etc. If a peer-to-peer connection is not possible, e.g., because either or both of the user device and the media storage device are behind a complex network infrastructure or other network limitations, such as blocked ports or protocols (e.g., UDP), the TURN (Traversal Using Relays around NAT) protocol will be used, with the fallback server 112 acting as the required relay server.

If a connection using TURN is not possible, e.g., the media storage device is offline, the fallback server 112 will serve as a cache for the encrypted media files until the media storage device is available to receive the files. The fallback server 112 may comprise any device capable of performing the functionality described herein with respect to the fallback server, e.g., a desktop or laptop computer, a server computer, etc. The fallback server includes a processor and a memory. The fallback server keeps a database or lookup table in the memory that associates each cached file with a media storage device. When a media storage device queries the fallback server for cached files, e.g., when it is started up, is reconnected to the internet after being offline, as a regularly-scheduled query, etc., the fallback server will send its associated cached files to the media storage device.

The system may also include one or more frames 108, which are configurable to be able to display or otherwise play back the media stored in media storage device 104. Frames are user devices with access to the media storage device, but have only read permissions to the media files. They are not generally given write or back up permission. Each frame may be associated with a media collection and/or a media with specific metadata such as tags. A frame will, in general, show the pictures in the media collection in some sequence, e.g., a loop or randomly, as would be known by one of ordinary skill in the art.

User devices 106 are configured to be able to take pictures, capture video, record sounds, or otherwise create media files.

After a media file is created, it may be backed up to media storage device 104, depending on account settings. Metadata may also be created for the media file, including, e.g., geographical information such as geotags, creation date and time, last modified date and time, length (for video and audio media), etc.

Tags may also be added as metadata for the file. Tags may be added manually by a user, or may be automatically generated by methods or algorithms run on the media storage device. For example, image recognition algorithms may identify the people or faces in an image or video, and tag the image or video with an appropriate tag. Image recognition algorithms may identify objects and/or scenery present in the image or video, e.g., animals (dogs, horses, etc.), landscapes (forest, field, snow, etc.), etc.

Event tags may also be added to the media, by accessing a calendar and comparing the date and/or time the media was created with the date and/or time of a calendar event. The calendar may be a user-created calendar, and the event may be specific to the user (e.g., the user's birthday). Alternative or additionally, the calendar may be a region-specific calendar (e.g., a country-specific calendar), and the event may be a national holiday, e.g., Thanksgiving in the United States.

After tags are added to the media files, the media files may be added to existing or newly created media collections. Media files with a manually-added tag are added to a media collection containing media files with that tag. For example, if the user selects several media files and adds the tag “cute,” those media files will be added to a media collection containing all media files with the “cute” tag. The system may automatically title a newly created media collection by the tag name.

Media files with tags based on image recognition, e.g., facial recognition, may be added to media collections based on the identified person or object. For example, all photos identified as including a particular person based on facial recognition may be added to a media collection titled as that person. Certain images may need to be confirmed by a user, e.g., where the image recognition algorithm returns a result with less confidence. The user's response, identifying the photo as containing the particular person or not, may be used to improve the image recognition algorithm.

Media files with tags based on calendar events may be added to media collections based on the identified event. For example, all photos identified as being taken during a calendar event, e.g., within the scheduled start and end times, may be added to a media collection titled as that event.

Media collections may also be automatically created and named based on any combinations of tags and/or other metadata. For example, a user may take pictures during a calendared theater performance. Person A and Person B may be of interest to the user, and the media storage device may be configured to use image recognition to automatically identify Person A and Person B in photographs. After the performance is over, and the photos are backed up to the media storage device, the media storage device may add a “theater performance” tag to each of the photos taken during the performance, a “Person A” tag to each photo including Person A, and a “Person B” tag to each photo including Person B. The media storage device may then automatically create media collections: “theater performance,” including all photos with the “theater performance” tag; “Person A,” including all photos with the “Person A” tag; and “Person B,” including all photos with the “Person B” tag. Media collections titled “theater performance-Person A” and “theater performance-Person B” may also be created, each including photos of the theater performance that also include the named person.

The metadata, including any added tags, combined with the access permissions, control which users have access to the media file. Thus, a sharing functionality is provided.

A notification may be sent to all or a subset of users that have access to the new media file, informing them of the existence of the new file. This notification can take the form of, e.g., an email, a text message, a push notification on the user's downloaded application, etc.

In addition, the media may be actively shared based on pre-defined rules. Sharing rules comprise at least two fields, the accounts with which the media is shared, and a trigger causing the media to be shared. The accounts may be defined by, e.g., email accounts, phone numbers, etc. The triggers may be defined based on any metadata stored for the media, e.g., person recognized, date, etc.

After the media file is backed up, it may be retrieved from media storage device 104 by a user device 106 associated with the media storage device and played back or displayed on the user device. A user may search for particular media files based on any of the information stored for the media files, e.g., tags, creation date, creation time, etc. The media file may also be added to one or more media collections that control what is displayed on frames 108.

A user device 106 or frame 108 may allow interaction with a displayed media file. A user may be able to zoom into and out of a picture, e.g., by selecting a point to zoom into, or using a gesture such as a pinch. A user may also be able to select an identified person, face, or other object and have the picture zoomed into that object.

Interaction data for media files may be identified and stored. Interaction data may include a view count for each file and a count for identified persons, faces, and/or objects that are zoomed into by a user or otherwise interacted with.

Communication between user device 106 and media storage device 104 may use an encryption method, e.g., public/private encryption keys, symmetric keys, etc. In one embodiment, media data is encrypted using a symmetric key and other communication, including transmitting the symmetric key, is encrypted using a public key (either the user device or the media storage device, depending on the recipient of the data).

In general, the functionality described herein is implemented in one or more computer applications. The functionality of the computer application(s) implementing the steps of the various method embodiments can be distributed between the components of the system, including the media storage device, the user devices, the authentication server, and the fallback server, in various ways. A specific implementation of the computer application(s) may require several different computer processes, with one or more separate processes running on the media storage device, one or more separate processes running on the user devices, one or more separate processes running on the authentication server, and one or more separate processes running on the fallback server. Each device or server may run their portion of the computer application(s) as an in-browser component, stand-alone or installed computer application, a mobile application, a downloadable app, via a scripting language such as Javascript, etc.

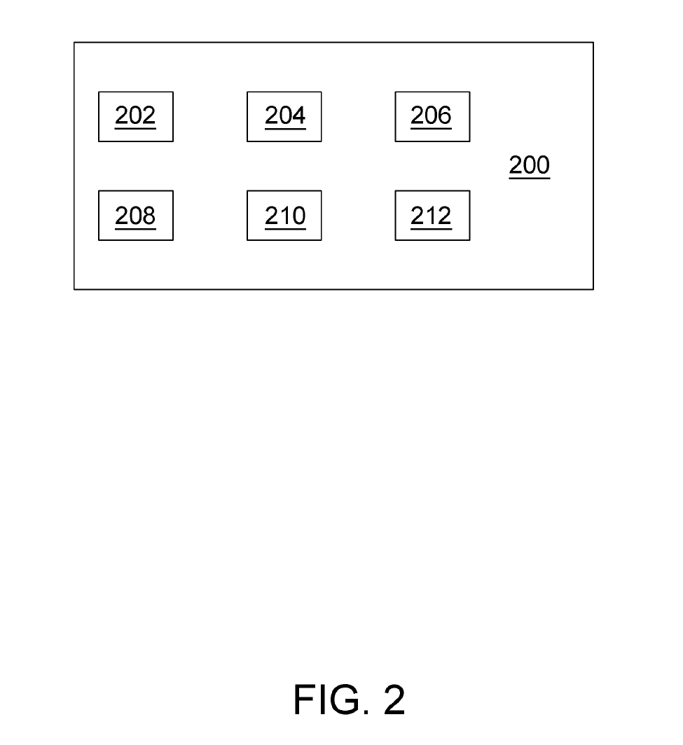

FIG. 2 illustrates one embodiment of a media storage device 200. Electronic components of media storage device 200 may include, but are not limited to one or more: processors 202; memory devices 204; wired and/or wireless communication devices 206; input/output ports 208, user interface devices and/or displays 210; and lights and other output devices 212. Each of the electrical components may be housed within the media storage device body and may be placed in communication with one another via wired or wireless electrical connections throughout the interior of the media storage device body.

Media storage device 200 may have a user interface directly on the device that indicates the status of the device. This user interface may include any number of visual components such as lights, and audio components such as speakers and microphones, to communicate with users.

The media storage device may include one or more i/o ports, e.g., USB (Universal Serial Bus), COM (serial), LPT (parallel), SCSI (Small Computer Systems Interface), IEEE 1394 (FireWire), PS/2, Ethernet, etc. These i/o ports may be used to import media or other files or information into the media storage device. For example, a camera may be plugged into a USB port on the media storage device, and the pictures on the camera may be automatically backed up to the media storage device.

The i/o ports may also be used to attach a storage medium, such as a hard disk drive. An attached storage medium may act as primary backup storage (in the case where the media storage device does not include any internal storage), secondary backup storage, or redundant storage.

The electronic components comprising the media storage device may be contained in a housing. The housing may be designed to be small, unobtrusive, and/or aesthetically pleasing.

Electronic components of a frame 108 may include, but are not limited to one or more: processors; memory devices; wired and/or wireless communication devices; batteries; input/output ports; user interface devices; and lights and other output devices. Each of the electrical components may be housed within the frame body and may be placed in communication with one another via wired or wireless electrical connections throughout the interior of the media storage device body. Frames 108 include a screen, e.g., a LCD, touch screen, color e-ink screen, etc., for displaying photos and/or other images. A user interface device included in a frame 108 may comprise several pressure-sensitive buttons or areas enabling a user to interact with the frame, e.g., display a menu, make menu selections, cycle through displayed images, etc. In one embodiment, a frame may include left, right, up, down, and OK buttons.

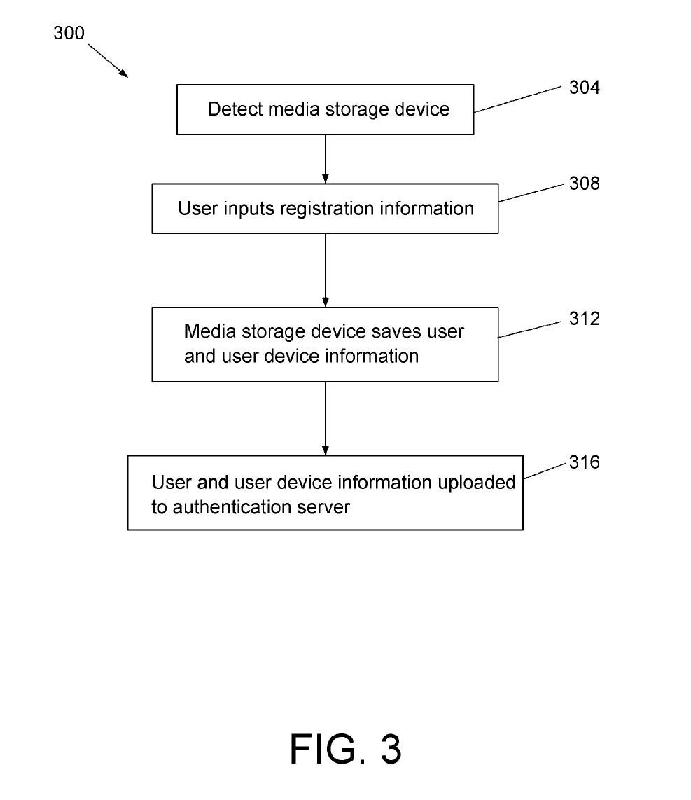

Reference is made to FIG. 3, which illustrates a first or owner user registration method 300. This method may be performed for the first user to access a particular media storage device.

In step 304, the user downloads or otherwise obtains any required application for the user device, and the application detects the media storage device over the local network. In one embodiment, the media storage device may include a particular word or set of characters, e.g., “Capsule”, etc., in its network id so the user device application can identify it as a media storage device.

In step 308, the user is presented with a registration screen, and registers with the media storage device. The registration can be done using a unique user id (e.g., email address, etc.) and password, or by using a third-party authentication provider, e.g., Facebook, Twitter, Google, etc., and a third-party authentication protocol, e.g., OAuth, etc.

In step 312, the media storage device saves the user and user device information. This first user is assigned the role of owner, and/or is given all permissions.

In step 316, the media storage device uploads the saved user and user device information to the authentication server, and the authentication server saves the information and creates an association between the user device and the media storage device. The authentication server can then authenticate the user when the user is not on the local network of the media storage device.

After the above steps have been performed for the new user, the user can start backing up media files from their user device and accessing media files stored on the media storage device.

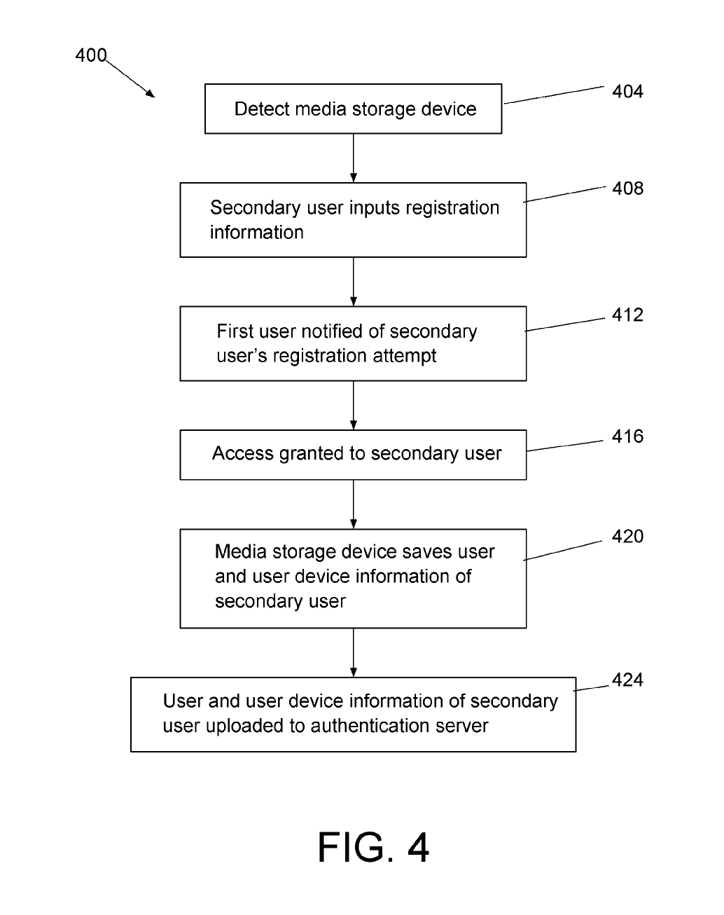

Reference is made to FIG. 4, which illustrates a secondary or subsequent user registration method 400. This method is performed each time a user after the first user attempts to access the media storage device locally.

In step 404, the secondary user downloads or otherwise acquires any required application for the user device, and the application detects the media storage device over the local network. In one embodiment, the media storage device may include a particular word or set of characters, e.g., “Capsule”, etc., in its network id so the user device application can identify it as a media storage device.

In step 408, the secondary user is presented with a registration screen, and registers with the media storage device. The registration can be done using a unique user id (e.g., email address, etc.) and password, or by using one of the third-party authentication providers, e.g., Facebook, Twitter, Google, etc., and a third-party authentication protocol, e.g., OAuth, etc.

In step 412, the media storage device notifies the first user that the secondary user is attempting to access the media storage device. In addition to the first user, the notification may be sent to other users with access granting permissions.

In step 416, the first user (or other user with access granting permission) grants access to the secondary user.

In step 420, the media storage device saves the secondary user and secondary user device information.

In step 424, the media storage device uploads the secondary user and secondary user device information to the authentication server, and the authentication server saves the information and creates an association between the user device and the media storage device. The authentication server is then enabled to authenticate the secondary user when the secondary user is not on the local network of the media storage device.

After the above steps have been performed for the new secondary user, the secondary user can start backing up media files from their user device and accessing media files stored on the media storage device.

As part of step 416, or any time subsequent to method 400, the first user, or another user with the appropriate permissions, can set or alter the permissions of the secondary user.

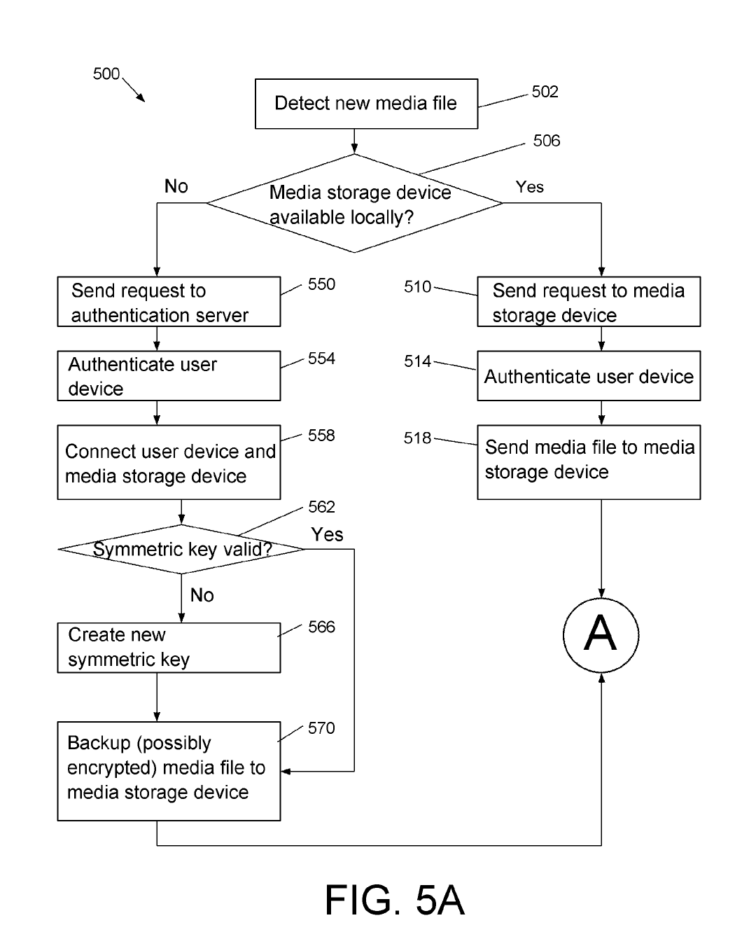

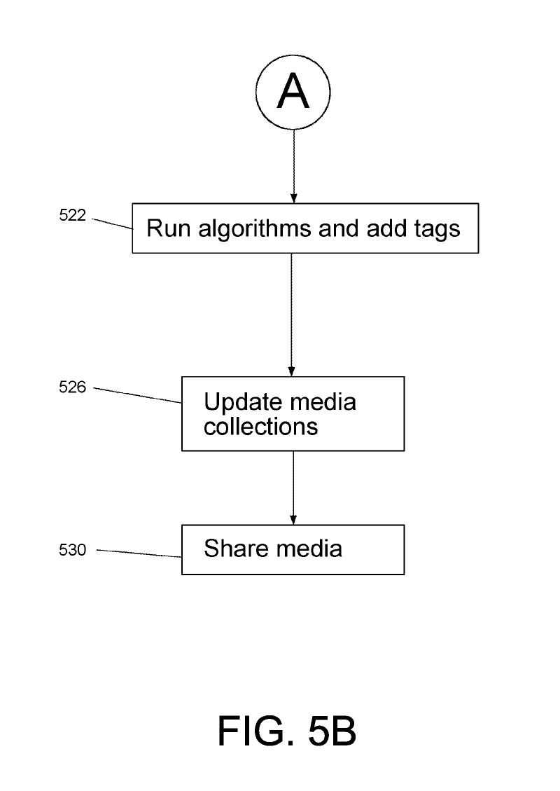

Reference is made to FIGS. 5A and 5B, which illustrates a backup process 500 from the user device to the media storage device.

In step 502, the user device detects that a new media file, e.g., image, audio, video, etc., has been created on the device. The detection of the new media file may be managed by a background process running on the user device. In one embodiment, the application keeps a list of all previously detected media files on the user device. When the application detects a new media file, through operating system hooks, function calls, querying an operating system indexing service, or file system scanning, the application will search its list to see if the media file is on the list. If the media file is not on the list, the application adds the file to the list. The file may be marked for later backing up, or may be backed up immediately.

The user device may also detect a change to a media file, and marked the changed file for backup (or immediately back up the changed file). A change to a file may be determined based on a change in timestamp, size, etc.

In one embodiment, for media files that aren't immediately backed up, an event, e.g., a location or zone change, an alarm, a ‘smart’ trigger, etc., may trigger the backup process. For example, a user may configure the application so the files are only backed up when on his or her home Wifi network. An alarm may be set to go off at a fixed time. A smart trigger may also be used, which can take into account multiple factors, e.g., likelihood of connectivity over WiFi, whether the device is in an idle charging mode (e.g., the user device is plugged in but isn't presently being user). In this embodiment, all files marked for backup are backed up when the backup process is triggered.

In some embodiments, the user may indicate, through application settings, that only certain photos are to be backed up. Backing up may be based on location, time, photo contents, people, etc. For example, only photos taken during certain hours of the day, photos taken within a specific geographic area (e.g., within a certain distance of a location), photos taken outside of a geographic area, photos with a particular person or object in them, etc., may be backed up. These settings may be stored on a user or user device basis.

In step 506, the user device determines if its associated media storage device is accessible locally, e.g., over a wireless network. This may be determined via network discovery or other means that would be known to one of ordinary skill in the art. In one embodiment, the user device looks for the id of the associated media storage device. To prevent another device from impersonating the media storage device (colloquially known as an “evil twin”), techniques such as verifying SSL signatures may be used. If the associated media storage device is found locally, the method proceeds to step 510. If the associated media storage device is not accessible locally, the method proceeds to step 550.

In step 510, the user device sends a request to the media storage device indicating that there is a new media file that needs to be backed up. The request includes the user device id, and may be sent in a secure manner, e.g., a JSON Web Token (JWT) signed with the user's private key. In one embodiment, the request also includes metadata of the new media file.

In step 514, an authentication check regarding the user device is performed. If the request was sent securely, the authentication check first verifies the query by, e.g., using the user's public key. In addition, the media storage device compares the sent user device information with the user device information stored in the media storage device. For example, the media storage device may look up the user device (using the unique id of the user device) in the internal user device table, to determine if the user device has the required status (e.g., active status) to access the media storage device. If the authentication check fails, the method ends. If the authentication check is passed, the method proceeds to step 518.

In step 518, the media storage device determines if the file needs to be backed up based on the received metadata. For example, if a user takes a picture and shares it with a family member using the same media storage device, the same file may be found on both the original user's and the family member's devices, but should only be backed up once. The media storage device may determine that the media file has already been backed up. In addition, the media storage may determine based on a comparison of metadata with pre-defined backup rules that the media file does not need to be backed up, e.g., the user doesn't want to backup photos taken at the user's workplace, and the metadata indicates that the photo was taken at the user's workplace.

If the media storage device determines that the media file needs to be backed up, then the user device communicates with the media storage device to upload the media file to the media storage device, along with related metadata.

In step 522, the media storage device runs algorithms as described above with respect to the uploaded media. These algorithms may generate tags to be added to the media metadata.

In step 526, the media storage device updates and/or creates media collections based on the media type and metadata. After a media collection is updated, other users or frames may request the new media file.

In step 530, if active sharing is implemented, the media storage device shares the uploaded media file with others based on metadata. The sharing may be performed via email, social media networks, etc. The person with which the media file is shared may need to have previously downloaded a particular application in order to receive the media file. Notifications to users regarding the new media may also be sent in this step. The method 500 then ends.

In step 550, the user device sends a connection request to the authentication server 110. The connection request by the user device includes information needed to authenticate the user device against the media storage device it is attempting to connect to. This information may include, e.g., media storage device id, user id, and user device id. The connection request may be sent in a secure manner, e.g., a JSON Web Token (JWT) signed with the user's private key.

In step 554, authentication server 110 authenticates the user device against the media storage device that the user device is associated with, and that the user device is currently allowed access to the media storage device. If authentication fails, the method ends and the media backup will not happen. If the authentication is successful, the method proceeds to step 558.

In step 558, if the user device passes authentication, authentication server 110 attempts to create a peer to peer (P2P) connection between the user device and the media storage device. If the P2P connection fails, fallback server 112 may be used as a relay point to pass data between the user device and media storage device, e.g., using a communication protocol, such as the TURN (Traversal Using Relays around NAT) protocol, etc. Fallback server 112 will act as the required relay point. If no connection is possible with the media storage device, e.g., because of a network failure and the media storage device being offline, the fallback server will temporarily cache the encrypted media from the user device until the media storage device is available and requests it from the fallback server. The authentication server then sends the connection information to the user device.

In step 562, the media storage device determines if the symmetric key for the requesting user device is valid. In one embodiment, symmetric encryption keys are rotated on a regular basis, and symmetric keys are considered invalid a defined amount of time after their creation. Also, a symmetric key for a particular user device may be considered invalid when the user or user device's status is set to blocked, or if any tampering has been detected. If the symmetric key is valid, the method proceeds to step 570. Otherwise, the method proceeds to step 566.

In step 566, the media storage device generates a new symmetric key and encrypts it with the public encryption key of the user device. The encrypted symmetric key is then sent to the user device either directly through the P2P connection or via the fallback server 112. On receipt of the encrypted symmetric key, the user device then decrypts it (using its private key) and stores the symmetric key for later use. Alternatively, other types of data encryption besides public/private keys may be used to securely send the symmetric key to the user device.

In step 570, the user device sends the media file, along with metadata, to the media storage device through the P2P connection or via the fallback server 110. The media file may first be encrypted using the stored symmetric key. The media storage device receives the media file and metadata, decrypts it using the symmetric key (if the media file is encrypted), and stores it. The method then proceeds to step 522.

In one embodiment, purely remote secondary users, e.g., extended family members living in a different household, must first be invited to use the system by a currently registered user with sufficient permission. In this embodiment, these types of secondary users will only be allowed access to specified media, and are not allowed to back up files. They may be allowed access to one or more particular media collections, or media with specified metadata, based on stored permissions. The media they are allowed to access is identified at the time the invitation is sent, but may be changed later by a user with appropriate permissions.

A currently registered user may use the user device application to send the invitation to the new user via a contact method, e.g., email, phone number, SMS, MMS, third-party account information (e.g., Facebook, Google, Twitter, etc.), etc. The invitation may include a one-time password or other authentication information to be entered by the new user as part of the registration process. The invitation may also include the media files that the new secondary user will be allowed to access.

After the new user receives the invitation and accepts it, the new user may need to download the user device application. After, the new user's application will work with the media storage device and authentication server to complete the registration process, including creating accounts for the new user on the media storage device and authentication server, exchanging any required keys (e.g., public keys, symmetric keys, etc.), etc.

After the non-local user has registered successfully, they will be able to access the media files based on their access permissions. Media files of non-local secondary users are not backed up.

In any of the above embodiments or methods, an additional backup may be created, thus providing redundancy. The additional backup may be made to a different media storage device. The different media storage device may be local or remote. Alternatively, the additional backup may be made to a generic storage device, such as a hard drive.

Unless specifically stated otherwise, as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

Embodiments of the subject matter and the functional operations described in this specification can be implemented in one or more of the following: digital electronic circuitry; tangibly-embodied computer software or firmware; computer hardware, including the structures disclosed in this specification and their structural equivalents; and combinations thereof. Such embodiments can be implemented as one or more modules of computer program instructions encoded on a tangible non-transitory program carrier for execution by, or to control the operation of, data processing apparatus (i.e., one or more computer programs. Program instructions may be, alternatively or additionally, encoded on an artificially generated propagated signal (e.g., a machine-generated electrical, optical, or electromagnetic signal) that is generated to encode information for transmission to suitable receiver apparatus for execution by a data processing apparatus. And the computer storage medium can be one or more of: a machine-readable storage device, a machine-readable storage substrate, a random or serial access memory device, and combinations thereof.

As used herein, the term “data processing apparatus” comprises all kinds of apparatuses, devices, and machines for processing data, including but not limited to, a programmable processor, a computer, and/or multiple processors or computers. Exemplary apparatuses may include special purpose logic circuitry, such as a field programmable gate array (“FPGA”) and/or an application specific integrated circuit (“ASIC”). In addition to hardware, exemplary apparatuses may comprise code that creates an execution environment for the computer program (e.g., code that constitutes one or more of: processor firmware, a protocol stack, a database management system, an operating system, and a combination thereof).

The term “computer program” may also be referred to or described herein as a “program,” “software,” a “software application,” a “module,” a “software module,” a “script,” or simply as “code.” A computer program may be written in any form of programming language, including compiled or interpreted languages, or declarative or procedural languages, and it can be deployed in any form, including as a standalone program or as a module, component, subroutine, or other unit suitable for use in a computing environment. Such software may correspond to a file in a file system. A program can be stored in a portion of a file that holds other programs or data. For example, a program may include one or more scripts stored in a markup language document; in a single file dedicated to the program in question; or in multiple coordinated files (e.g., files that store one or more modules, sub programs, or portions of code). A computer program can be deployed and/or executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as but not limited to an FPGA and/or an ASIC.

Computers suitable for the execution of the one or more computer programs include, but are not limited to, general purpose microprocessors, special purpose microprocessors, and/or any other kind of central processing unit (“CPU”). Generally, CPU will receive instructions and data from a read only memory (“ROM”) and/or a random access memory (“RAM”). The essential elements of a computer are a CPU for performing or executing instructions and one or more memory devices for storing instructions and data. Generally, a computer will also include, or be operatively coupled to receive data from or transfer data to, or both, one or more mass storage devices for storing data (e.g., magnetic, magneto optical disks, and/or optical disks). However, a computer need not have such devices. Moreover, a computer may be embedded in another device, such as but not limited to, a mobile telephone, a personal digital assistant (“PDA”), a mobile audio or video player, a game console, a Global Positioning System (“GPS”) receiver, or a portable storage device (e.g., a universal serial bus (“USB”) flash drive).

Computer readable media suitable for storing computer program instructions and data include all forms of nonvolatile memory, media and memory devices. For example, computer readable media may include one or more of the following: semiconductor memory devices, such as erasable programmable read-only memory (“EPROM”), electrically erasable programmable read-only memory (“EEPROM”) and/or and flash memory devices; magnetic disks, such as internal hard disks or removable disks; magneto optical disks; and/or CD-ROM and DVD-ROM disks. The processor and the memory can be supplemented by, or incorporated in, special purpose logic circuitry.

To provide for interaction with a user, embodiments may be implemented on a computer having any type of display device for displaying information to a user. Exemplary display devices include, but are not limited to one or more of: projectors, cathode ray tube (“CRT”) monitors, liquid crystal displays (“LCD”), light-emitting diode (“LED”) monitors and/or organic light-emitting diode (“OLED”) monitors. The computer may further comprise one or more input devices by which the user can provide input to the computer. Input devices may comprise one or more of: keyboards, a pointing device (e.g., a mouse or a trackball). Input from the user can be received in any form, including acoustic, speech, or tactile input. Moreover, feedback may be provided to the user via any form of sensory feedback (e.g., visual feedback, auditory feedback, or tactile feedback). A computer can interact with a user by sending documents to and receiving documents from a device that is used by the user (e.g., by sending web pages to a web browser on a user's client device in response to requests received from the web browser).

Embodiments of the subject matter described in this specification can be implemented in a computing system that includes one or more of the following components: a backend component (e.g., a data server); a middleware component (e.g., an application server); a front end component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Non-limiting examples of communication networks include a local area network (“LAN”) and a wide area network (“WAN”), e.g., the Internet.

The computing system may include clients and/or servers. The client and server may be remote from each other and interact through a communication network. The relationship of client and server arises by virtue of computer programs running on the respective computers and having a client-server relationship to each other.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

1. A method for backing up a file from a user device to a media storage device, the method comprising:
determining, at the user device, that a new media file has been created on the user device;
detecting if the media storage device is accessible via a local network;
sending a connection request to an authentication server upon detecting that the media storage device is not accessible via the local network;
receiving, from the authentication server, information regarding a connection between the user device and the media storage device; and
transferring the media file to the media storage device using the received connection information.

2. The method of claim 1, wherein the media file is encrypted prior to being transferred to the media storage device.

3. The method of claim 1, wherein the connection between the user device and the media storage device is a peer-to-peer connection.

4. The method of claim 1, wherein the connection between the user device and the media storage device uses a fallback server.

5. The method of claim 4, wherein the fallback server caches the media file if the media storage device is not accessible.

6. The method of claim 1, further comprising the steps of
receiving the media file at the media storage device;
analyzing the content of the media file to determine an attribute of the media file;
adding the media file to a media collection based on the attribute; and
transferring the media collection to a frame device remote from the media storage device.

7. The method of claim 6, wherein the step of analyzing comprises image recognition of a person.

8. A media backup system comprising:
a user device;
an authentication server; and
a media storage device;
wherein the user device comprises:
a memory operable to store instructions;
a processor communicatively coupled to the memory, the processor operable to execute the instructions to:
determine that a new media file has been created on the user device;
detect if the media storage device is accessible via a local network;
send a connection request to the authentication server upon detecting that the media storage device is not accessible via the local network;
receive, from the authentication server, information regarding a connection between the user device and the media storage device; and
transfer the media file to the media storage device using the received connection information.

9. The system of claim 8, wherein the media file is encrypted prior to being transferred to the media storage device

10. The system of claim 8, wherein the connection is a peer-to-peer connection.

11. The system of claim 8, wherein the connection uses a fallback server.

12. The method of claim 11, wherein the fallback server caches the media file if the media storage device is not accessible.

13. A method for connecting a user device to a media storage device, wherein the user device is paired with the media storage device, the method comprising:
receiving, at an authentication server, a request to connect the user device to the media storage device;
creating a connection between the user device and the media storage device, the connection enabling the user device to copy a media file to the media storage device; and
sending, to the user device, information regarding the connection.

14. The method of claim 13, wherein the connection between the user device and the media storage device is a peer-to-peer connection.

15. The method of claim 13, wherein the connection between the user device and the media storage device uses a fallback server.

16. The method of claim 15, wherein the fallback server is configured to cache the media file if the media storage device is not accessible.

17. The method of claim 13, wherein the connection request is authenticated prior to creating the connection.

18. The method of claim 13, further comprising the steps of
receiving the media file at the media storage device;
analyzing the content of the media file to determine an attribute of the media file;
adding the media file to a media collection based on the attribute; and
transferring the media collection to a frame device remote from the media storage device

19. The method of claim 13, wherein the authentication server stores an association between a device id of the user device and a device id of the media storage device.

20. The method of claim 19, wherein the user device stores the device id of the media storage device.
